(19) United States
(12) Patent Application Publication
(10) Pub. No.: US 2004/0201130 A1
(43) Pub. Date: Oct. 14, 2004

(54) Method of producing polyurethane surfaces

(76) Inventors: Paul Kampe, Nisseguogue, NY (US); Brian Kampe, East Setauket, NY (US)

Correspondence Address: GOTTLIEB RACKMAN & REISMAN PC, 270 MADISON AVENUE, 8TH FLOOR, NEW YORK, NY, 100160601

(21) Appl. No.: 10/818,992

(22) Filed: Apr. 6, 2004

Related U.S. Application Data
(63) Continuation-in-part of application No. 10/410,378, filed on Apr. 9, 2003.

(51) Int. Cl. B29C 31/00

(52) U.S. Cl. 264/219; 264/240

(57) ABSTRACT

A method of making a decorative polyurethane panel which replicates the look of a pre-selected material is provided. A full size model of the material is first created having the desired texture and appearance. A tooling is then constructed to contain the model. The model of the material is encased with a two part silicone rubber compound that fills said tooling. The newly formed silicone mold is then removed from the tooling. Polyurethane components are separately mixed. The polyurethane mixture is then dispensed into the mold. The filled mold is covered with a vent paper. The mold is then fed into a press and pressure is applied. The mold is removed from the press and the newly created panel is then removed from the mold and allowed to cure. An outer finish is then applied to the panel so that it resembles the decorative appearance of the material.

This application is a continuation-in-part of application Ser. No. 10/410,378, filed Apr. 9, 2003.

### BACKGROUND OF THE INVENTION

The invention relates to a method of making a polyurethane surface material. Specifically, the invention provides a method of making a surface material for various structural and design purposes that replicates a real material.

Polyurethane surfaces create a more realistic appearance for display and aesthetic purposes. Designers, producers, and purchasers often look for highly detailed, textured, dimensional display units or display components, but may be limited to custom molded parts.

U.S. Pat. No. 5,010,133 to Seville discloses a high pressure polyurethane molding composition, method and article. U.S. Pat. No. 5,167,991 to Lowe discloses a method for producing a replicated stone surface. U.S. Pat. No. 4,960,622 to Jarboe et al. discloses an artificial urethane rock.

The present invention provides a process wherein standard sized sheets of polyurethane are produced at a low cost. These sheets have a considerably lower weight than their original counterparts.

### SUMMARY OF THE INVENTION

The present invention relates to a method of producing a decorative polyurethane panel which replicates the look and texture of a material such as stone, wood or metal. A full size model of the material is first created having the desired texture and appearance. A tooling is then constructed to contain the model. The model of the material is encased with a two part silicone rubber compound that fills this tooling. The silicone rubber compound is cured in the tooling. In order to contain the mold to be produced, a box filled with polyurethane is cast therearound. The newly formed silicone mold (with the box) is then removed from the tooling.

Thereafter, isocyanate and polyol components are mixed together to form polyurethane, as is well known in the art. The polyurethane mixture is then dispensed into the mold, which has been pre-painted with a pigmented mold release. The filled mold is covered with a vent paper that allows air to escape. A mold top is placed over the vent paper. The mold is then fed into a press and pressure is applied, with the mold top preventing the mixture from escaping the mold. The mold is then removed from the press and the vent paper and the cover are removed from the mold. The newly created panel is then removed from the mold and allowed to finish curing. An outer finish, which may include a stain, paint and/or UV inhibitor, is then applied to the panel so that it resembles the model surface.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

FIG. 1 shows a flow chart illustrating the steps in making polyurethane surface;

FIG. 2 shows a flow chart of the making of the polyurethane;

FIG. 3a shows a sample of a replicated slate surface;

FIG. 3b shows a sample of a replicated barn board surface;

FIG. 3c shows a sample of a replicated bark surface; and

FIG. 3d shows a sample of a replicated brick surface, and

FIG. 4 shows a panel sample formed with finger joints.

### DETAILED DESCRIPTION OF THE PREFERRED EMBODIMENT

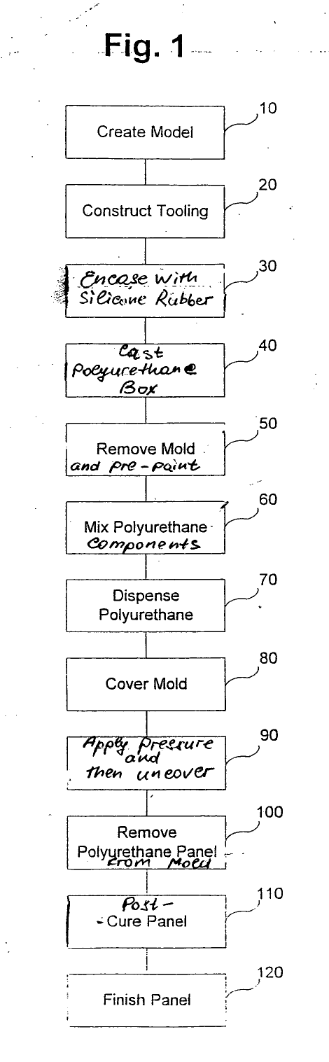

Referring in detail to the drawings, FIG. 1 shows a flow chart of those steps involved in making a polyurethane surface. A full-sized model of the material having the desired texture and appearance is first produced in step 10. Suitable materials include but are not limited to asphalt, natural rock, slate, bamboo, brick, barn board, driftwood, stonewall, headboard, concrete and tree bark. The full size model is preferably leveled to achieve a constant thickness. The model is preferably a 2′×4′ panel so that the resulting replicated material is also a 2′×4′ section. However, panels may also be manufactured in 4′×4′, and 4′×8′ sizes, or panels of any other predetermined size as is desired. Alternatively, the model may be configured to be any geometric shape without departing from the inventive concept.

A tooling made of a wood or metal material, and designed to contain the full size model, is constructed in step 20. Particularly, the full size model is mounted on a flat board which is oversized by about 2-4 inches on all four sides. The sides are then framed by typically a plywood material in order to contain the silicone rubber, as described below.

Silicone rubber compound is encased within the tooling in step 30. The silicone compound is a two-part compound well known in the art and commercially available from various chemical companies. The silicone compound is first thoroughly mixed, deaerated and then poured over the full size model. The silicone compound is then cured in order to produce a mold. Because the model is encased in the tooling, the curing silicone rubber is prevented from expanding beyond the four sides of the tooling. In step 40, a box filled with polyurethane is cast around the mold. The newly formed silicone mold (with the box) is removed from the full size model and tooling in step 50, heated to between 100°-150° F., and its surface is then painted or sprayed with a pigmented mold release agent, similar to a water-based paint.

Polyurethane is mixed in step 60. Isocyanate and polyol components, which are used to produce polyurethane as is well known, are preferably pumped through a computer controlled system that regulates the dispensing of the components to the hundredth of a second. The two components are dispensed into a computer controlled mixing head and then dispensed into the mold in step 70. Alternatively, the polyurethane components may be hand mixed and then dispensed. Preferably, the mixture is placed in the mold, with the mixture equally distributed across the mold's surface.

The polyurethane mixture-filled mold is covered in step 80. A vent paper is used to cover the mold in order to allow air to escape. The vent paper is then covered with a plywood.

The covered mold is placed into a high-pressure press (1,000-20,000 pounds per square inch) and pressure is applied in step 90. The plywood top prevents the urethane foam from escaping the mold. The opening or stopping of the press is timed (by a timing device or manually) which opens the mold (removes it away from the press) on a pre-set timed basis. The vent paper is then removed from the press and the newly formed polyurethane panel is removed or uncovered from the mold in step 100. The panel is easily removed from the mold due to the presence of the mold release agent. The panel is permitted to cure in step 110 and then finished in step 120. Finishing the panel preferably includes painting, sealing and/or coating (such as with a UV inhibitor) the panel to achieve a desired finish depending on the surface that is being replicated. Curing takes an average of 24 hours and the newly formed panel is stored on a flat surface until curing is complete.

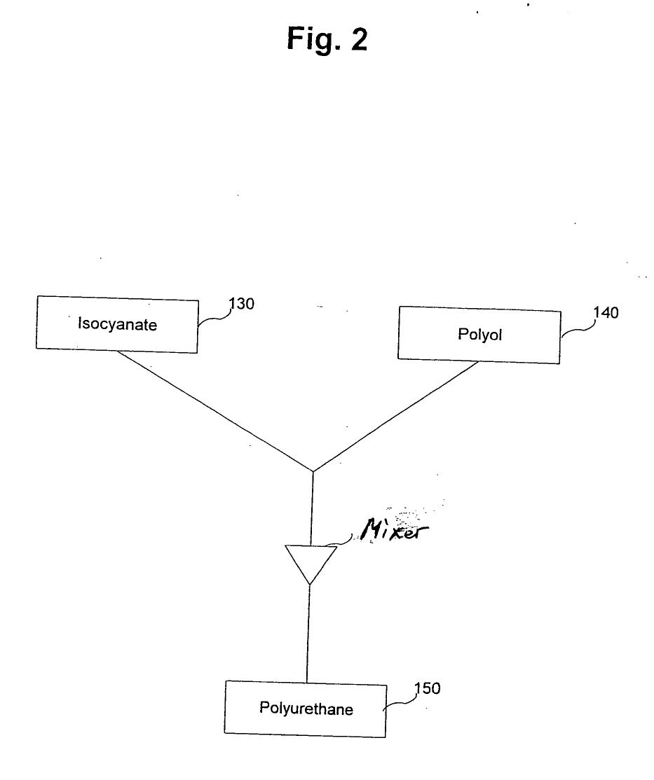

FIG. 2 is a schematic block diagram shown the creation of the polyurethane. Isocyanate 130 and polyol 140 are combined in a mixer head to form a polyurethane mixture 150.

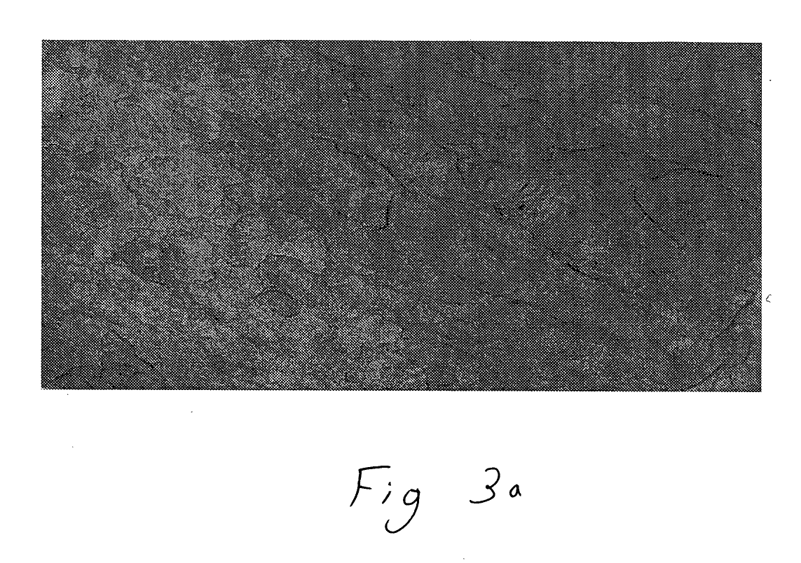

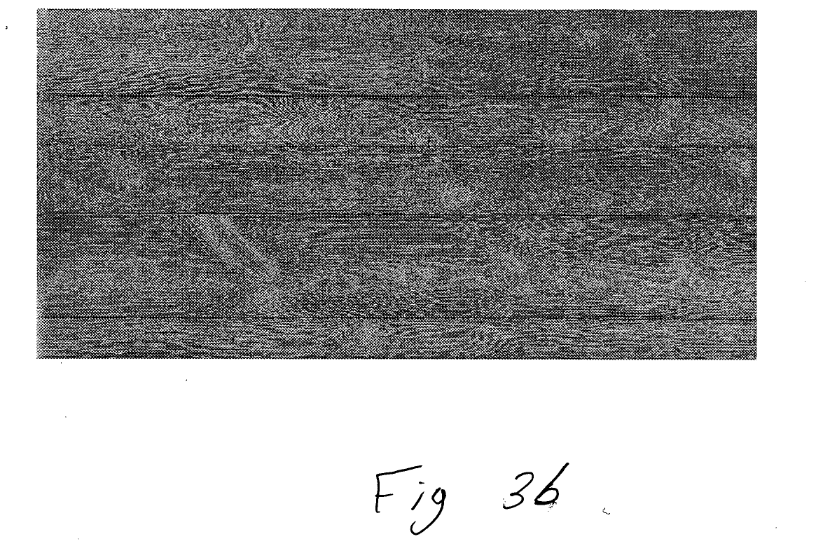

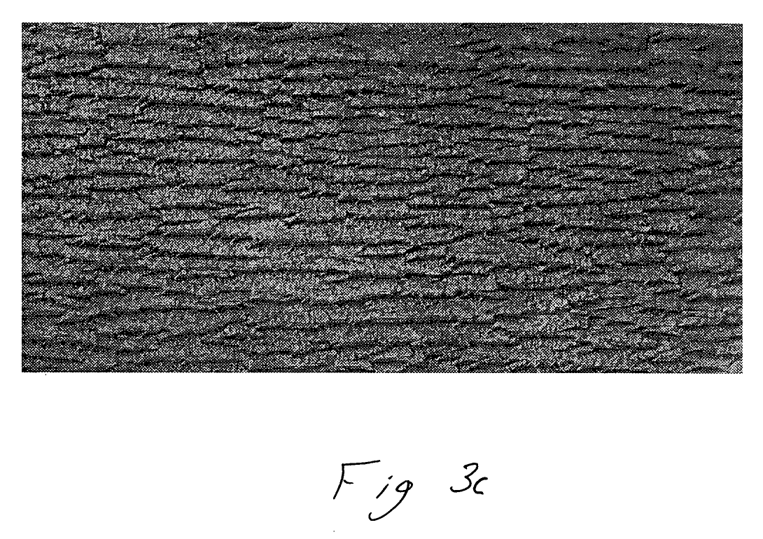

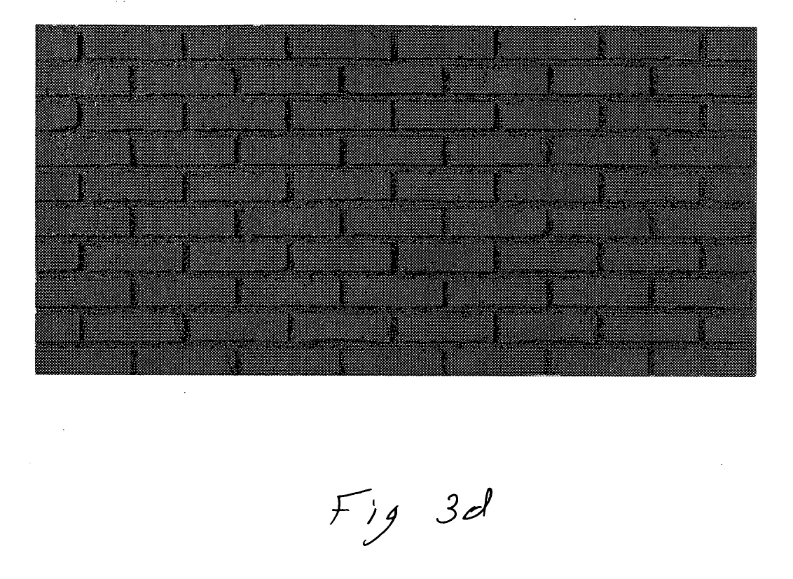

This method may produce an unlimited amount of replicated polyurethane panels, four of which are shown in FIGS. 3a-d. FIG. 3a shows a replicated slate panel. FIG. 3b shows a sample of a replicated barn board panel. FIG. 3c shows a sample of a replicated tree bark panel. FIG. 3d shows a sample of a replicated brick surface. Other possible surfaces include asphalt, concrete, sand, stone, small beach stone, large river stone, diamond plate, bamboo, wainscot, and stone wall.

The inventive panels are produced having a molded density of between about 6 and 64 lbs/cubic foot in both fire and non-fire rated polyurethanes.

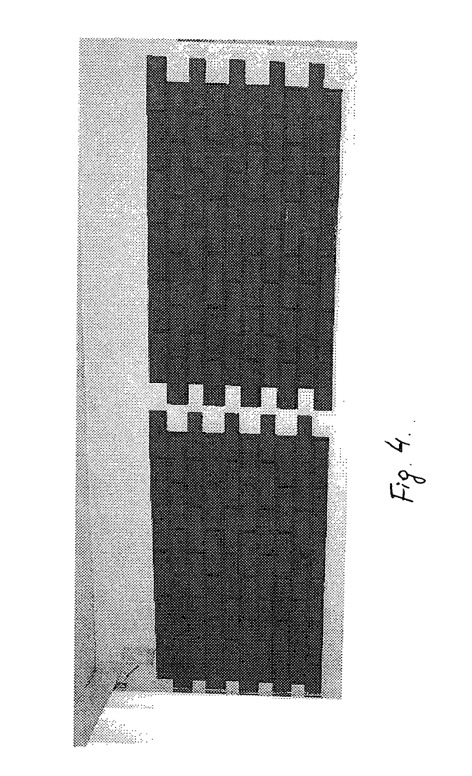

In one embodiment, as shown in FIG. 4, the panels of the invention may be formed with finger joints in order to facilitate a seamless appearance during assembly.

The inventive method enables the production of stock decorative polyurethane panels having various surface designs. The stock decorative panels of any one design are used to create a facade or wall having a particular desired look.

Accordingly, while several embodiments of the present invention has been shown and described, it is obvious that many changes and modifications may be made thereunto without departing from the spirit and scope of the invention.

1. A method of producing standard size polyurethane panel which replicates the look and texture of a pre-selected solid material comprising the following steps:
constructing a mold based on a full-size model of said material;
filling said mold with only a polyurethane mixture in order to form a polyurethane panel;
removing said formed panel from said mold; and
applying an outer finish to said panel.

2. The method of claim 1, further including the step of producing the model of said material having said look and texture of said pre-selected solid material.

3. The method of claim 1, wherein said model is encased with a silicone compound.

4. The method of claim 3, wherein said silicone compound is cured in order to produce said mold.

5. The method of claim 1, wherein a box filled with polyurethane is cast around said mold.

6. The method of claim 1, wherein a mold release agent is applied to said mold.

7. The method of claim 1, wherein said polyurethane mixture is prepared by mixing isocyanate and polyol components.

8. The method of claim 1, wherein said filling step includes substantially equally distributing said polyurethane mixture across said mold.

9. The method of claim 1, further including the step of covering the mold following said filling step.

10. The method of claim 9, wherein vent paper covers said mold.

11. The method of claim 1, wherein pressure is applied to the mold following said filling step.

12. The method of claim 11, wherein the applied pressure is between about 1,000 and 20,000 pounds per square inch.

13. The method of claim 1, wherein said panel is cured following said removing step.

14. The method of claim 1, wherein said step of constructing a mold further comprises the steps of:
mounting said model on a board oversized on all sides and framing all sides.

15. The method of claim 3, wherein said step of encasing said model further comprises pouring said silicone compound over said model.

16. The method of claim 7, wherein said step of mixing said isocyanate and polyol components further comprises regulating said mixing of said components through a computer controlled system and dispensing said mixture from a computer regulated mixing head in order to fill said mold.

17. The method of claim 13, wherein said panel is cured for at least 24 hours.

18. The method of claim 1, wherein said step of applying an outer finish comprises at least one of painting said panel, sealing said panel and coating said panel.

19. The method of claim 6, wherein said release agent is water based.

20. A method of forming a surface made from a plurality of panels produced in accordance with claim 1 comprising the step of interlocking said panels by means of finger-joints depending therefrom.
